(19) United States
(12) Patent Application Publication
(10) Pub. No.: US 2007/0094133 A1
(43) Pub. Date: Apr. 26, 2007

(54) Systems and methods for managing an expenditure cycle

(76) Inventors: Sudhir Anandarao, Vienna, VA (US); James W. Benefiel, Ashburn, VA (US); Fletcher D. Gill, Rockville, MD (US); Sreedhar V. Potarazu, Potomac, MD (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/253,803

(22) Filed: Oct. 20, 2005

(51) Int. Cl. G06Q 40/00

(52) U.S. Cl. 705/40

(57) ABSTRACT

The invention includes receiving a first data set that includes information associated with claims under a benefit plan. The first data set is searched for a first claim from the claims that includes at least one detail in common with a second claim from the claims. A report including the first claim and the second claim is generated. A duplication of a charge for the first claim or a duplication of charge for the second claim included in a vendor invoice received from a vendor is identified. The invention also includes comparing a first electronic data set that includes information associated with claims paid by a vendor to a provider, to a second electronic data set that includes claims included in a vendor invoice to an employer to determine if a claim from the claims included in a vendor invoice has been included in a claim paid to a provider.

### BACKGROUND

The present invention relates generally to financial risk management, and more particularly to systems and methods of managing and monitoring an expenditure cycle.

In a typical self-insured health benefits plan payment system, a vendor invoice is sent to an employer daily, weekly, or monthly or on some other periodic basis. The invoice is generally sent via fax, email, or mail, or is charged directly to the employer's bank account. The invoice can include a combination of charges including: self-insured claims, non-claims adjustments, and/or non-claims activity. One issue that can arise is that an invoice may not provide an adequate description of the charges, or a detailed itemization of the claims, non claims activities, and/or non claims adjustments included in the invoice. In fact, the invoice is typically a very simple payment request for funds, and typically only defines the requested amount as a sum (aggregate) total amount.

Without a detailed invoice, a number of problems can go unnoticed. For example, the following potential errors may be present regarding one or more claims included on an invoice, but not necessarily evident by the invoice itself:
1) the invoice amount is greater, or less than, the sum total of the items that are intended for inclusion in the invoice;
2) the invoice includes false claims (e.g., claims that were never actually submitted by a provider into the vendor's claim adjudication system);
3) the invoice includes claims that have been processed to completion by the vendor (adjudicated), but not actually paid to the provider (doctor or hospital submitting the claim);
4) the invoice includes claims that were actually submitted by a provider and actually processed to completion by the vendor, but are invalid because the employee associated with the claim was ineligible to receive the benefit; and
5) the invoice includes claims more than once (claims that were processed to completion in the adjudication system, but duplicated when passed into the billing system).

To confirm that the invoice is complete, accurate, and/or valid, an employer may request that the vendor submit a more detailed invoice including: an explanation of the charges included in the invoice, a complete and detailed list of claims (e.g., medical claims) included in the invoice, and an explanation of any additional charges (e.g., non claims activity, non claims adjustments, etc.). Rarely, however, does the vendor provide this level of detail.

Thus a need exists for a system and method of monitoring and managing an expenditure cycle, such as a self-insured health benefits plan payment cycle.

### SUMMARY OF THE INVENTION

The invention includes receiving a first data set that includes information associated with claims under a benefit plan. The first data set is searched for a first claim from the claims that includes at least one detail in common with a second claim from the claims. A report including the first claim and the second claim is generated. A duplication of a charge for the first claim or a duplication of charge for the second claim included in a vendor invoice received from a vendor is identified.

### BRIEF DESCRIPTION OF THE DRAWINGS

The present invention is described with reference to the accompanying drawings.

FIG. 1 a schematic illustration of an expenditure cycle for a self-insured health plan cycle.

FIG. 2 is a schematic illustration of a system according to an embodiment of the invention.

FIGS. 3-25 are illustrations of various example reports and screen-shots that can be generated according to various embodiments of the invention.

FIG. 26 is a flowchart of a method according to an embodiment of the invention.

FIG. 27 is a schematic illustration of a health benefits expenditure cycle according to an embodiment of the invention.

### DETAILED DESCRIPTION

Financial risk management (FRM) methods and systems can assist users in identifying existing internal controls and determining their effectiveness. FRM is intended to help control an employer's overall “Purchase to Pay Cycle” as it relates, for example, to the procurement, payment, and accounting of an expenditure cycle for a self-insured health benefits plan.

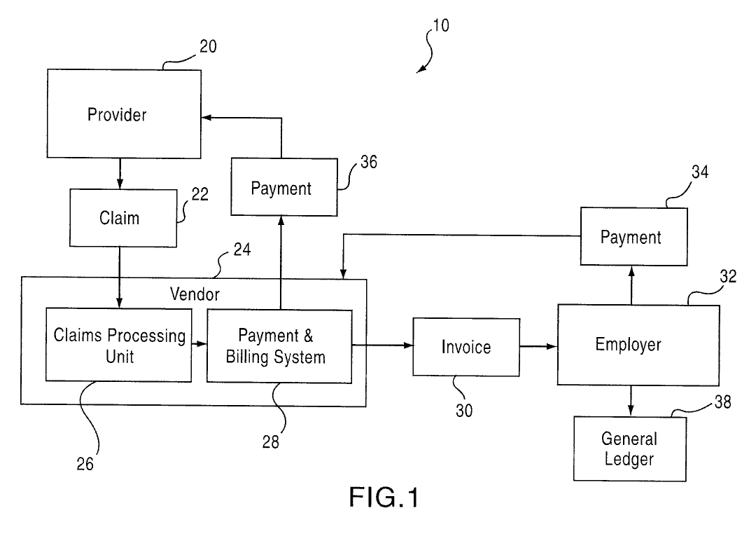

The functional block diagram of FIG. 1 illustrates a purchase to pay cycle (“expenditure cycle”) for a healthcare payment system for a self-insured employer. The first step in an expenditure cycle 10 is for a provider 20, such as a doctor, a hospital or other caregiver, to generate a claim 22, which is submitted to a claims processing unit 26 of a vendor 24. A claim 22 can be, for example, a claim for a medical procedure that has been performed on a patient who is included as a member of a self-insured health benefits plan. The vendor 24 can be, for example, a third party administrator of health or insurance benefits. The vendor claims processing unit 26 includes a claims adjudication system, which processes each submitted claim and transfers the processed claims to a vendor payment and billing system 28. The vendor payment and billing system 28 generates a payment 36 for each claim and sends the payment 36 to the provider associated with that claim. The vendor payment and billing system 28 also produces an invoice 30 to be sent to an employer 32. The employer 32, can be, for example, a health plan sponsor or owner of the self-insured benefits plan. The invoice 30 can include information regarding one or more claims for which the vendor has provided payment to a provider. The employer 32 processes the invoice 30 and generates a payment 34 that is sent to the vendor. The employer 32 also prepares an entry or posting associated with the claim to be added to a general ledger 38. The posting can include information associated with the claim, such as the claimed procedure, the claimant or patient, the amount of the payment associated with the claim, etc.

The following description describes how the invention can be implemented for use by an employer or other user and how the invention is applied to various components of an expenditure cycle. The description focuses on an expenditure cycle for a healthcare benefit plan, however, the invention can be implemented with other types of expenditure cycles.

The invention provides methods of manipulating, monitoring and evaluating data associated with an expenditure cycle. The methods can be embodied in one or more hardware and/or software programs. The methods of the invention are described herein as being embodied in computer programs (software and/or hardware) having code to perform a variety of different functions associated with an expenditure cycle, however, it should be understood that the methods are not limited to an electronic medium and can be alternatively practiced in a manual setting. All of the various methods described herein can produce reports and generate screen-shots in a variety of different formats. For example, reports can be generated in tabular format, graphical format, diagrammatical format, or chart format.

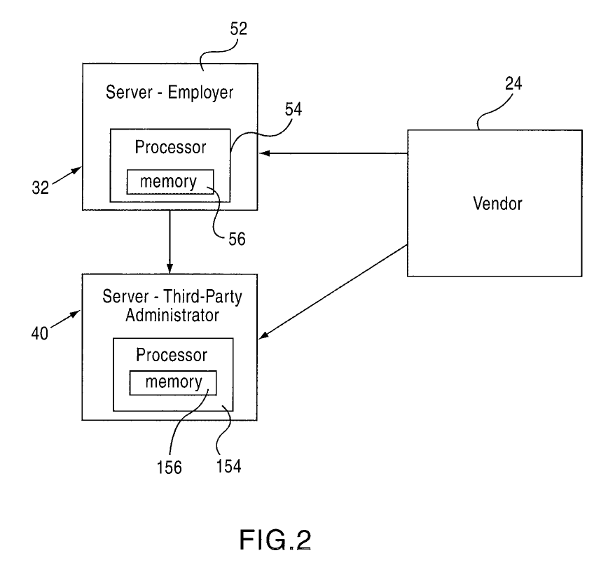

FIG. 2 is a schematic illustration of a system according to an embodiment of the invention. A server 52 according to an embodiment of the invention can be located at an employer site and/or located such that it is accessible by an employer. Server 52 includes a processor 54. The server 52 can be accessible by an employer and be in communication with one or more vendors via a broadband connection or other high-speed network. The processor 54 can be, for example, a commercially available personal computer, or a less complex computing or processing device that is dedicated to performing one or more specific tasks. For example, the processor 54 can be a terminal dedicated to providing an interactive graphical user interface (GUI). The processor 54, according to one or more embodiments of the invention, can be a commercially available microprocessor. Alternatively, the processor 54 can be an application-specific integrated circuit (ASIC) or a combination of ASICs, which are designed to achieve one or more specific functions, or enable one or more specific devices or applications. In yet another embodiment, the processor 54 can be an analog or digital circuit, or a combination of multiple circuits.

The processor 54 can include a memory component 56. The memory component 56 can include one or more types of memory. For example, the memory component 56 can include a read only memory (ROM) component and a random access memory (RAM) component. The memory component 56 can also include other types of memory that are suitable for storing data in a form retrievable by the processor 54. For example, electronically programmable read only memory (EPROM), erasable electronically programmable read only memory (EEPROM), flash memory, as well as other suitable forms of memory can be included within the memory component 56. The processor 54 can also include a variety of other components, such as for example, co-processors, graphic processors, etc., depending upon the desired functionality of the code.

The processor 54 is in communication with the memory component 56, and can store data in the memory component 56 or retrieve data previously stored in the memory component 56. The components of the processor 54 can communicate with devices external to the processor 54 by way of an input/output (I/O) component (not shown). According to one or more embodiments of the invention, the I/O component can include a variety of suitable communication interfaces. For example, the I/O component can include, for example, wired connections, such as standard serial ports, parallel ports, universal serial bus (USB) ports, S-video ports, local area network (LAN) ports, small computer system interface (SCCI) ports, and so forth. Additionally, the I/O component can include, for example, wireless connections, such as infrared ports, optical ports, Bluetooth® wireless ports, wireless LAN ports, or the like. The network to which the processor 54 is connected can be physically implemented on a wireless or wired network, on leased or dedicated lines, including a virtual private network (VPN).

A system and method of the invention can be accessed and operated by an employer, or alternatively by a third party administrator. As shown in FIG. 2, a third-party administrator 40 can include a server 152, and processor 154 (with memory 156). The third-party administrator 40 can, for example, manage and control an expenditure cycle for an employer and act as an intermediary between vendors and employers.

In some embodiments, a vendor 24 can include a processor as described above, that is in communication with the employer processor and/or a third-party administrator processor. This allows data and information to be shared between a vendor's adjudication and billing system and the employer and/or third-party administrator.

Various functional modules are described below that can be incorporated within a variety of different systems and methods of the invention.

Vendor Invoice Reviewer Modules

An embodiment of the invention includes a review process for vendor invoices that are received by an employer. The review process includes an automatic audit and review of vendor invoices and charges included within the invoice. The review process can help mitigate the risk of overcharges from a vendor and identify possible errors related to claims and/or the invoice information. A vendor invoice, such as invoice 30 illustrated in FIG. 1, can be sent to an employer daily, weekly, or monthly or on some other periodic basis. The invoice is generally sent via fax, email, or mail or is charged directly to the employer's bank account. The invoice can include a combination of charges including: self insured claims, non-claims adjustments, and/or non-claims activity.

To assist with an employer's invoice review and approval process, vendor invoice reviewer modules are provided that can, for example, include the following functions:
1) compare the sum total amount of the invoice with the sum total of all listed items included therein to confirm the accuracy of the invoice;
2) compare all claims in the invoice with all claims included in a vendor payment to a provider to confirm that all claims that fully qualify for inclusion in the invoice are included;
3) perform advanced data manipulation to identify any claims that have been duplicated when passed from the adjudication system at the vendor to the billing system at the vendor;
4) match every claim included in every invoice with evidence of that same claim in the vendor's claim adjudication system to confirm that the claim in the invoice is actually a real processed claim that was submitted by a doctor or hospital;
5) confirm that every claim included in the invoice includes a claimant that is on an enrollment and eligibility list to confirm that the claimant was eligible for the service; and
6) compare every claim included in the invoice with the claims identified in a check run back to the doctor or hospital (i.e., payment from the vendor) to confirm that the claim charged to the employer is a truly “paid claim” and that the claim was in fact processed to completion and released for payment (to the doctor or hospital from the vendor) before being included in an invoice.

The vendor invoice reviewer modules include two modules, (1) a claims and enrollment review module and (2) a provider payment reviewer and vendor invoice validator module. The claims auditor module automatically inspects an entire population of claims from a vendor's claims management/processing system and provides detailed reports and alerts about any duplicate and/or invalid (e.g., ineligible) claims identified for the employer. Examples of specific functions of this module include the following:
1) assess the vendor's claims processing system in terms of how well they are checking and approving claims from providers;
2) perform risk assessments to determine possible invoice error rates;
3) assess which vendor invoices have the highest error rates;
4) receive and communicate detailed monthly reports and alerts about all duplicate and/or invalid claims captured through the claims auditor; and
5) obtain evidence to recover any over-payments each month.

The claims and enrollment review module can be further broken-down into two functions: a “duplicate claims auditor” function and an “eligibility auditor” function.

The duplicate claims auditor function can be embodied on a processor-readable medium storing code representing instructions to cause a processor to receive first electronic data representing information associated with a plurality of claims under a benefit plan. The processor can automatically search and report on the identification of claims that possess at least one detail in common. Such details can include, for example, a patient name, a claim originator (i.e., provider), a claim incurred date, a claim service date, a claim paid date, a service code modifier, and a claim amount (i.e., dollar amount). Thus, a duplication of charge can be identified within a vendor invoice for the same claim within the electronic data received.

The eligibility auditor function can include, for example, an audit of both vendor invoice and eligibility data. This function can also be embodied on a processor-readable medium storing code representing instructions to cause a processor to compare first electronic data with second electronic data. The first electronic data set can represent, for example, information associated with a plurality of claims under a benefit plan. The second electronic data set can represent, for example, information associated with enrollment and eligibility records. The processor is configured to automatically identify any and all claims under the benefits plan with a corresponding claims incurred date, that cannot be matched to a respective enrollment/eligibility record for the same time period. Thus, claims that were assigned a paid date in the adjudication system and subsequently included in an invoice for unauthorized individuals (those not in the benefits plan at time the claim was incurred) can be identified. Errors in the enrollment/eligibility records can also be identified.

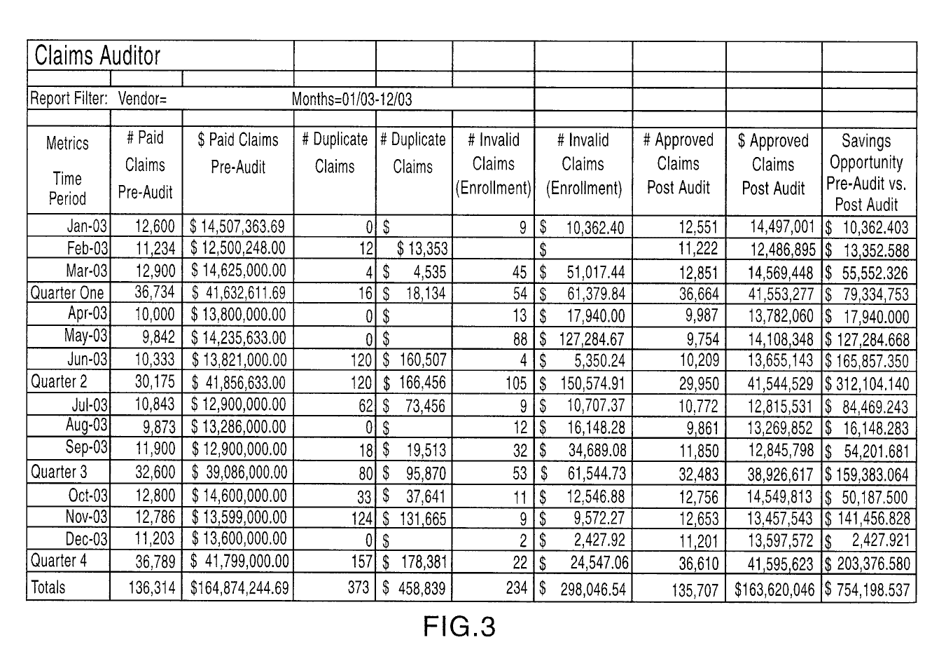

An example report that can be generated by the claims and enrollment review module is illustrated in FIG. 3.

The provider payment reviewer and vendor invoice validator module can automatically compare the entire population of approved claims for a given time period to the actual payment requests (invoices) submitted from a vendor associated with that time period. Examples of specific functions of this module are as follows:
1) identify and compare differences between processed claims and invoice totals;
2) identify any charges that can not be tied back to actual vendor payments to providers from the vendor's check clearing account;
3) identify opportunities for cost recovery;
4) receive and communicate alerts whenever invoice totals for the month or period are materially different than claims data/provider payments for the same month or period; and
5) develop adequate problem resolution procedures to mitigate the risk of over-payments.

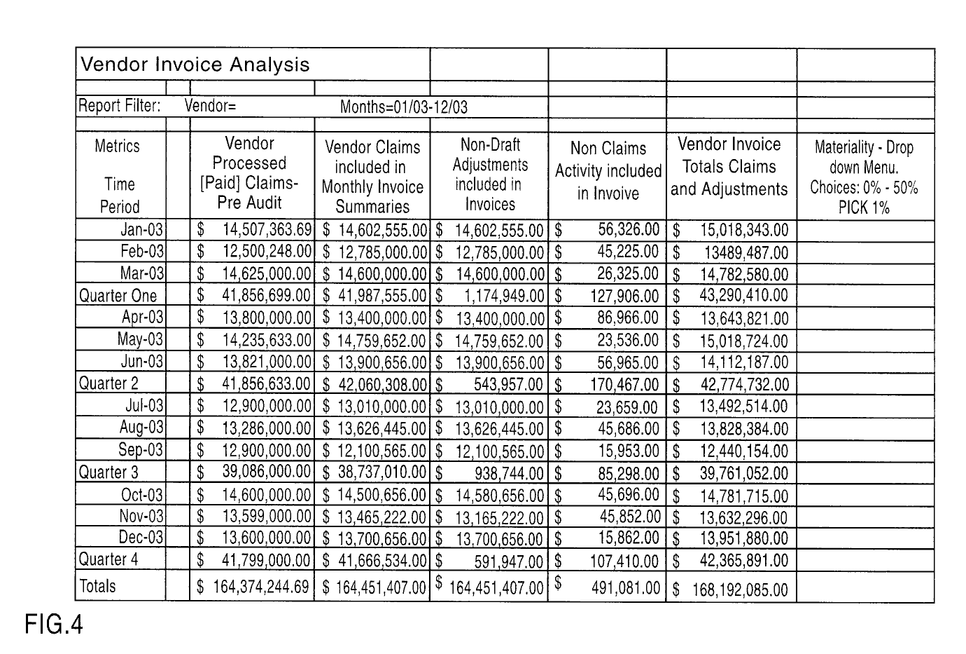

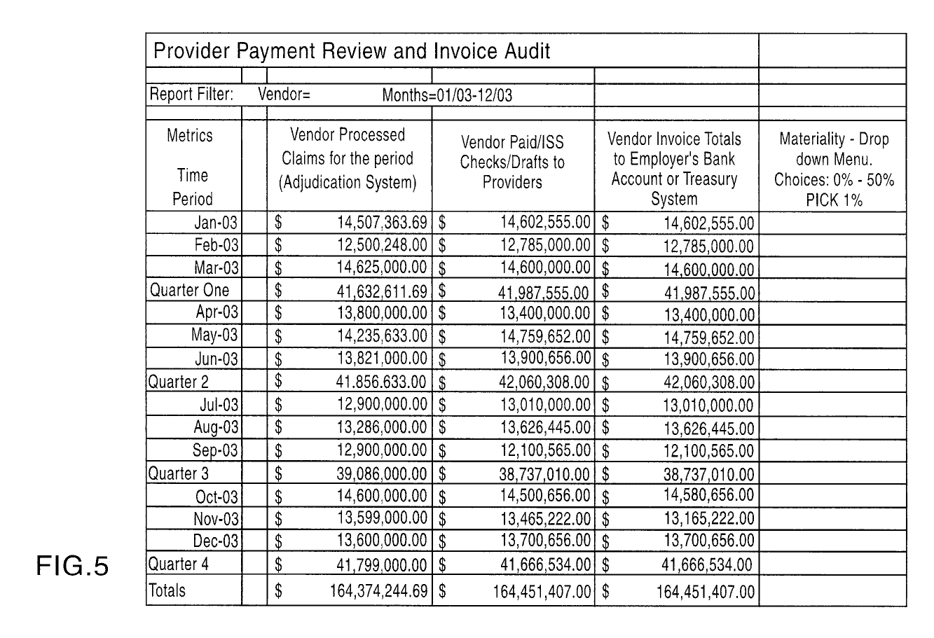

Example reports that can be generated by the provider payment reviewer and vendor invoice validator module are illustrated in FIGS. 4-5.

The provider payment reviewer and vendor invoice validator module can be embodied on a processor-readable medium storing code representing instructions to cause a processor to compare a first electronic data set with a second electronic data set, and the second electronic data set with a third electronic data set. The first electronic data set can represent, for example, information associated with a plurality of claims under a benefit plan. The second electronic data set can represent, for example, information associated with evidence of claims paid by a vendor to a provider (provider payments/check runs), and the third electronic data set can represent, for example, claims included in the vendor's actual invoice to the employer. The processor can automatically identify claims included in a vendor invoice that have or have not yet been included in a payment (check run) to a provider, or that can be validated as a truly submitted, processed, or adjudicated claim. Also, the processor can automatically identify any and all lags in time between when the employer is charged for a claim and when the claim is actually paid to a provider in the provider payment/check run.

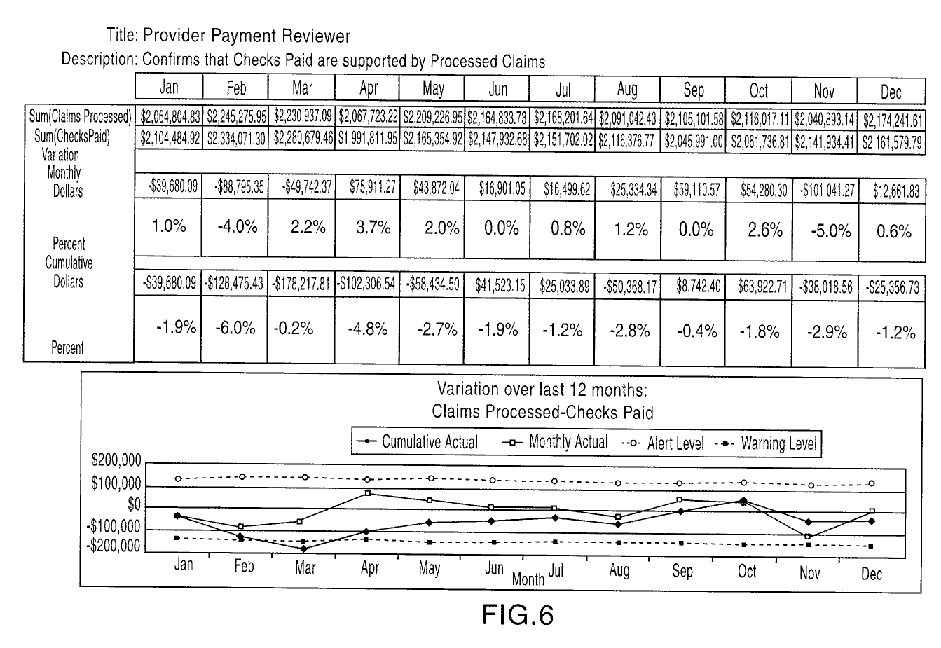

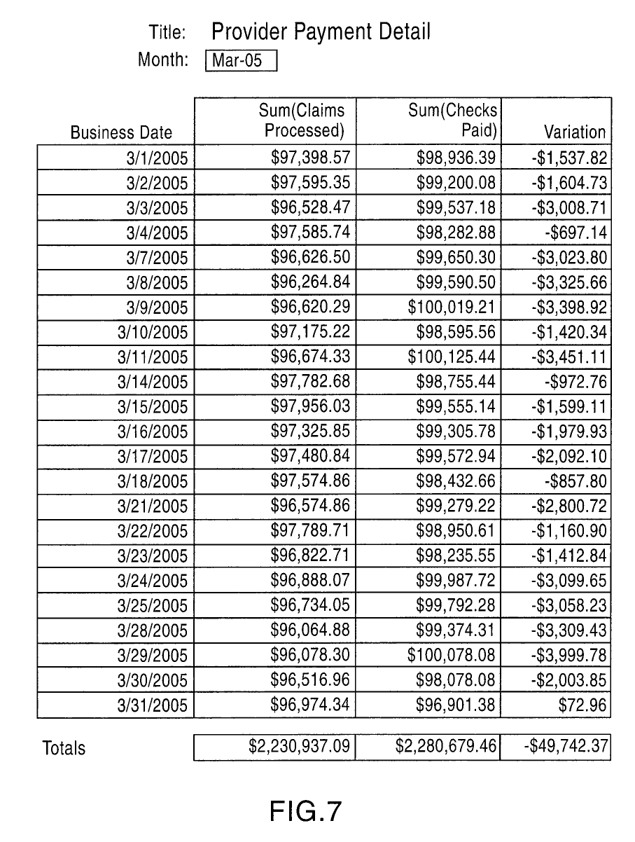

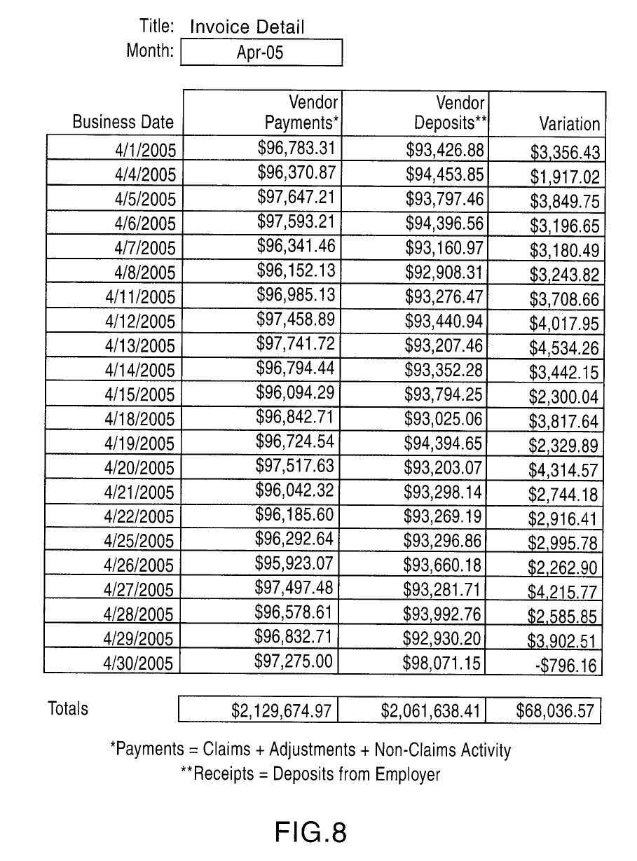

Additional example reports and screen-shots for the provider payment reviewer and invoice validator module of the first method are illustrated in FIGS. 6-13. FIG. 6 illustrates an example of a report that shows that all checks are supported by claims adjudicated through the vendor's claims processing system. This report is designed to confirm that all checks paid by the vendor are supported by claims adjudicated through the vendor's claims processing system. If a claim is not supported, an alert will be produced indicating specific dates where comparisons have shown discrepancies or inconsistencies. The employer or other user, can parse the data to successive levels of detail and determine the root cause of the discrepancy. FIG. 7 illustrates an example of parsed data that shows those dates when checks paid are not supported by claims adjudicated through the vendor's claims processing system. This report is designed to narrow in on the cause of the discrepancy between checks paid by the vendor and claims adjudicated through the vendor's claims processing system. The user can further parse this data for the date in question and determine the root cause. FIG. 8 illustrates another example of data that has been parsed and illustrates a report that shows those situations when vendor receipts are not supported by vendor payments through the vendor's check clearing account. This report is designed to narrow-in on the cause of the discrepancy between funding requested by the vendor and the payments made by the vendor. If the vendor is not netting adjustments against checks, then this report will show that the fund request of the employer is too large. The user can again parse the data to another detail level for the date in question to reconcile any discrepancy.

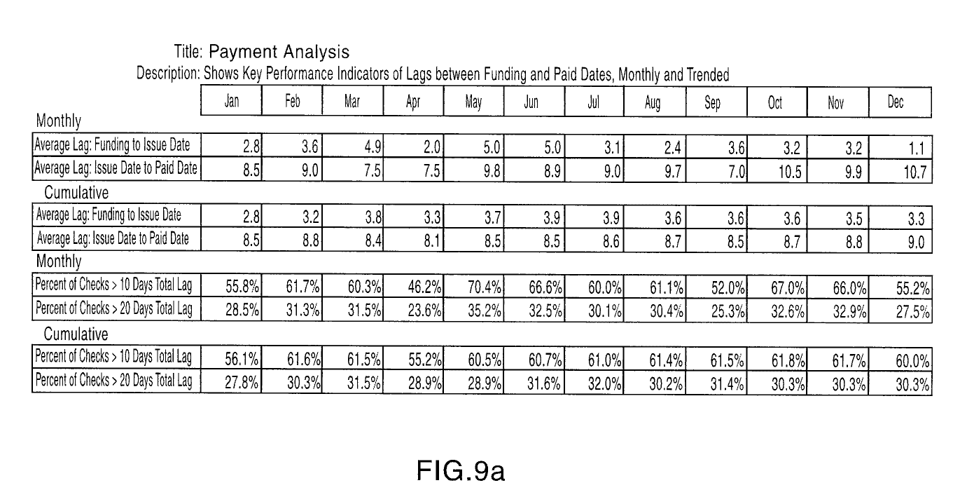

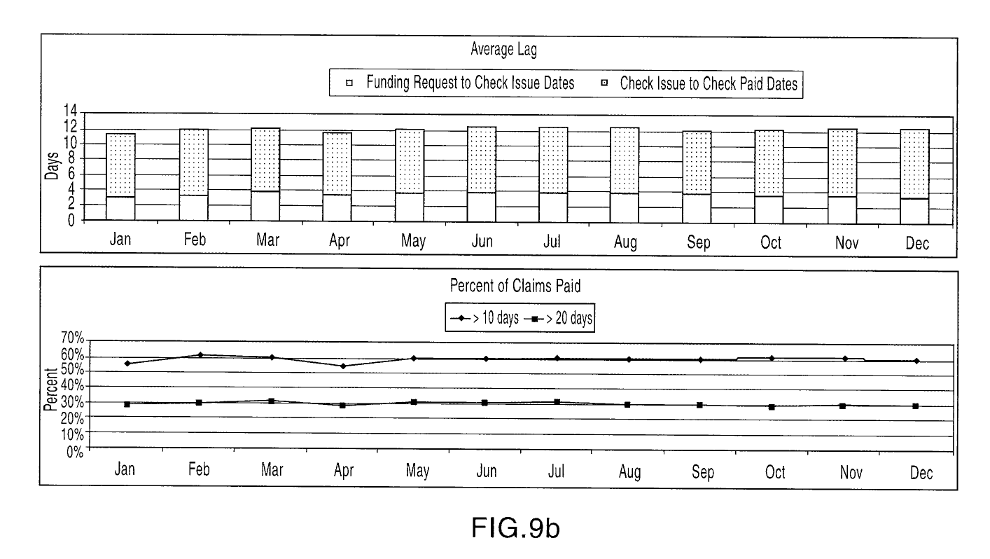

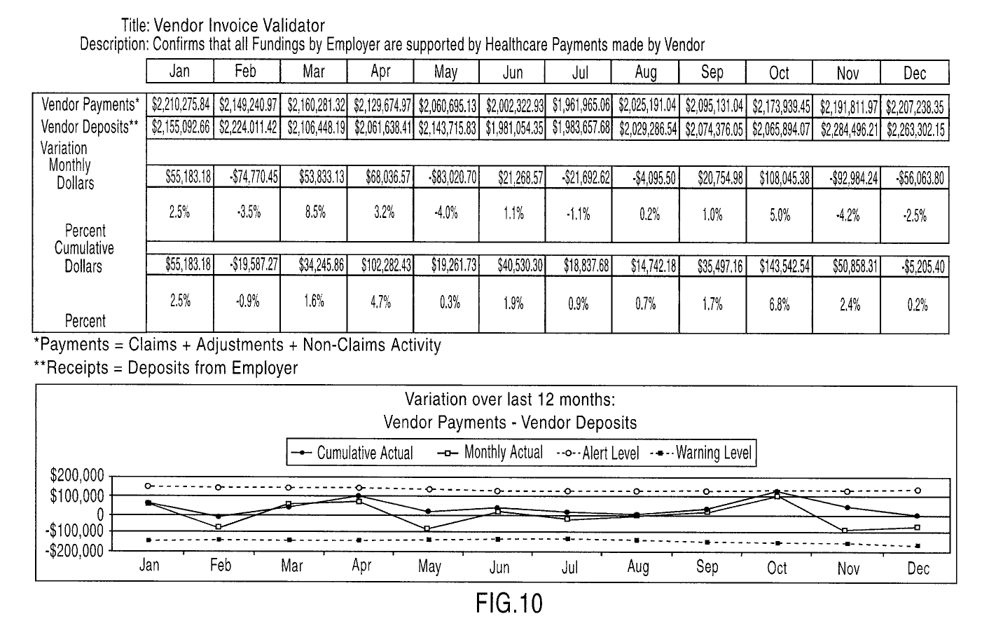

FIG. 9 illustrates a report that shows key performance indicators of lags between funding and paid dates, monthly and trended, and is designed to allow the user to compare check cashing lags for selected vendors, as lags can indicate the practice of fund floating by the vendor. FIG. 10 illustrates a report that confirms that all deposits made by the employer are supported by payments made by the vendor. This report is designed to confirm that all deposits made by the employer to the vendor were used by the vendor to write checks to providers and to pay related healthcare expenses. If not, an alert will indicate specific dates when such comparisons show discrepancies. Again, the user can parse the data to successive levels of detail to perform a root cause analysis and reconcile any discrepancy.

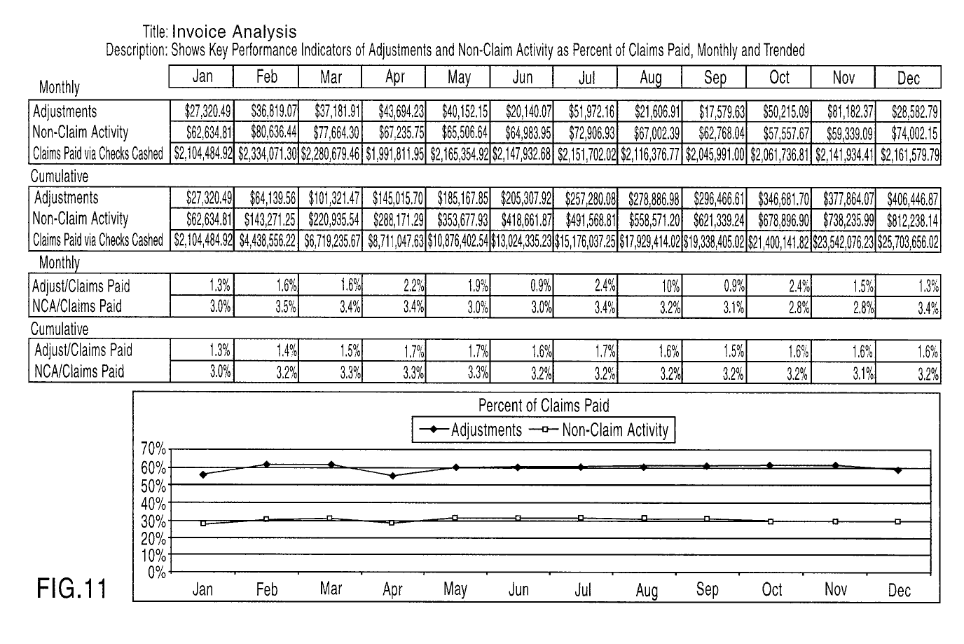

FIG. 11 illustrates a report showing key performance indicators of adjustments and non-claims activity, as a percent of claims paid. This report is designed to enable a user to compare non-claims expenses for selected vendors and determine whether there are any inefficiencies in the maintenance of bank accounts.

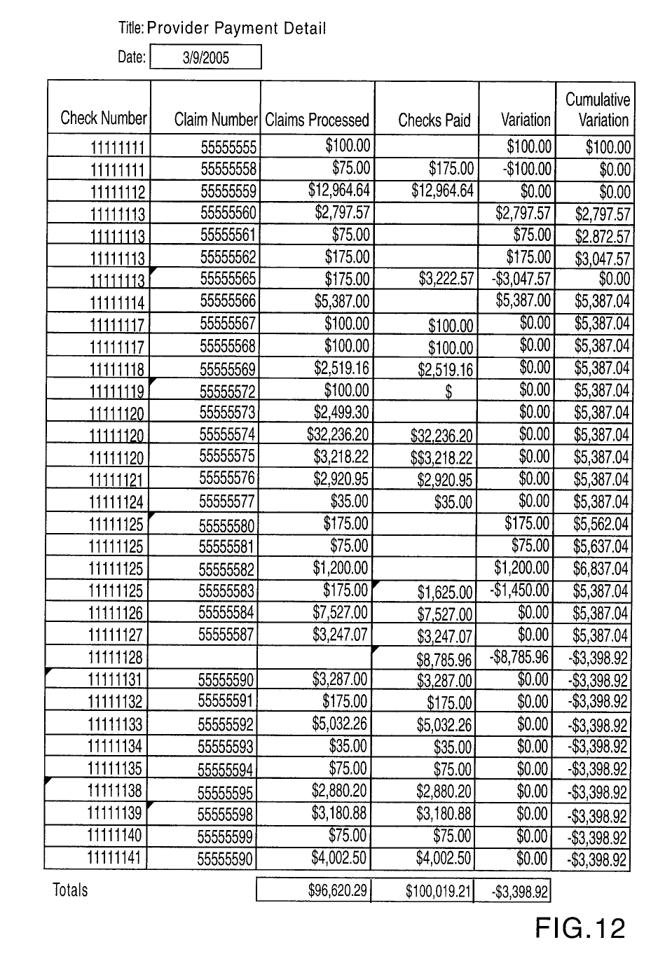

FIG. 12 illustrates a report that shows checks paid and claims adjudicated through the vendor's claims processing system for selected dates when the totals do not match. This report is designed to identify the source of discrepancies between checks paid by the vendor and claims adjudicated through the vendor's claims processing system

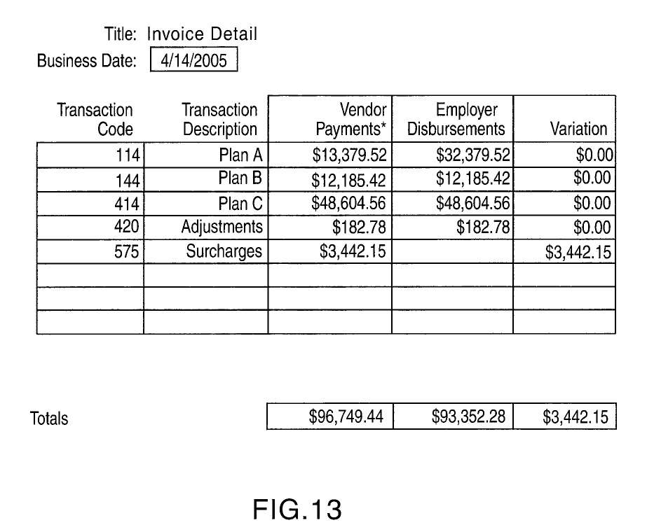

FIG. 13 illustrates a report that shows employer disbursements and vendor payments through the vendor's check clearing account for selected dates when the totals do not match. This report is designed to identify the source of discrepancies between disbursements made by the employer and payments made by the vendor.

Employer Fund Release Monitor Module

Another embodiment of the invention includes a module to support a more complete fund release review and approval process by performing an audit of every fund release (e.g., payment transaction) from the employer's bank account (e.g., allowance account) or employer treasury system. This can help to mitigate the risk of inappropriate fund releases, either to the vendor in question, or to an unauthorized location (e.g., payees, vendors, routing numbers).

As stated above, a vendor's invoice is typically sent to an employer daily, weekly, or monthly (i.e., on a periodic or batch basis). It can be sent via fax, email, or mail. Alternatively, the amount can be electronically charged directly to the employer's bank account. In the event payment is sent directly to the bank, the bank is responsible for releasing the funds. This is called “an automatic wire request and automatic fund release process.” In this case, the employer has no control over the amount of the invoice, the amount being automatically charged to the employer's bank account, or the amount the bank actually releases (be it to the vendor, to another routing number, payee, or location). When the invoice is submitted directly to the employer, the employer's representative can release the funds directly from the employer's treasury system. Risk exposure can exist in either of the above-described situations and can include, but may not be limited to the following:
1) the amount electronically charged from the vendor does not match the vendor's intended charge as stated in the vendor's hard copy invoice;
2) the funds released from the bank or treasury to the vendor are inaccurate (e.g., too much money); and
3) the bank releases funds to vendors/routing numbers/payees that have not been authorized.

The employer is typically responsible for implementing a set of internal controls (e.g., review and approval controls) to control the release of these cash assets and to mitigate the risk of lost assets due to, for example, the bank or treasury making unauthorized payments or accidental fund releases.

To support the employer's fund release (transaction activity) review and approval process, and to provide internal controls to confirm that each fund release (transaction) is complete, accurate, and valid, a module is provided that can, for example, include the following tasks:
1) compare the entire amount (in aggregate) of funds released from the bank account with the exact intended amount submitted by the vendor to the bank in electronic wire transfer requests for the same period; and
2) match the vendor's routing number with the routing number associated with every fund release transaction from the bank account.

This module is referred to as the employer fund release monitor module and can be embodied in a processor-readable medium storing code to compare a first electronic data set with a second electronic data set. The first electronic data set can represent, for example, information associated with a plurality of charges within a vendor's invoice and electronic wire transfer request (fund request). The second electronic data set can represent, for example, information associated with an employer's bank account transaction activity (e.g., debits, credits and payees in the account). Fund requests that cannot be matched to a respective fund release, or likewise, any fund releases (transactions) which cannot be matched to a pre-approved vendor fund request and/or a pre-approved routing number can be identified. Thus, amounts requested by unauthorized requesters, funds released to the appropriate vendor/routing number, but in the wrong amount, funds released to unauthorized vendors/routing numbers/payees, unauthorized access to create/change/delete fund releases, and amounts within the payments system; and/or the date, amount, and payee to whom the funds were released, can all be identified.

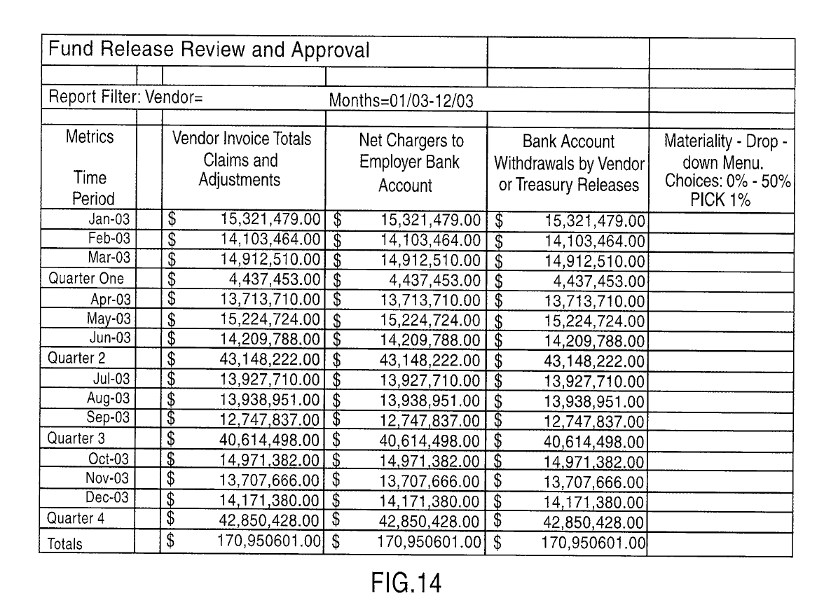

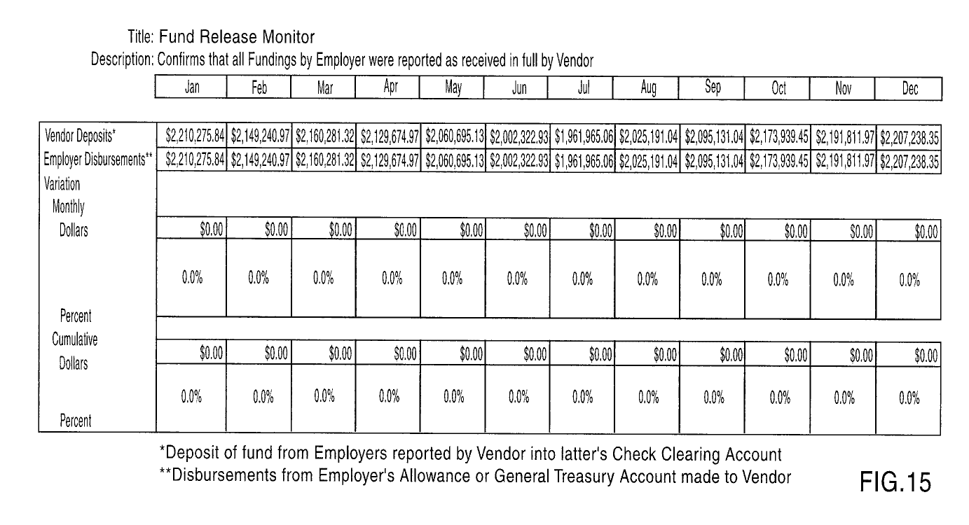

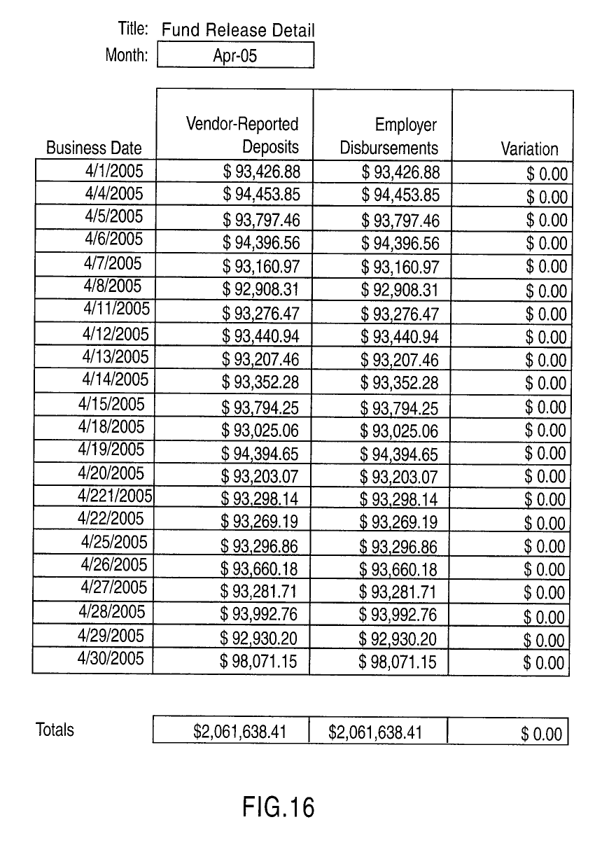

Example reports that can be generated by the employer fund release monitor module are illustrated in FIGS. 14-16. FIG. 14 illustrates an example report that shows vendor invoice totals, net charges to the employer's bank account and withdrawals from the employer's bank account. FIG. 15 illustrates a report that shows that all fund releases made by the employer are reported as received in full by the vendor. This report is designed to confirm that all disbursements made by the employer were received by the vendor and not diverted in transit. An alert would indicate specific dates when such comparisons show discrepancies. When entries are balanced, this report confirms that none of the funds were siphoned off by the employer's staff, bank staff, vendor staff, or any other unauthorized recipient of the funds intended for member healthcare expenses as requested by the vendor. As with previous reports, the user can parse the data to successive levels to determine the root cause of any discrepancy. FIG. 16 illustrates fund release data that has been parsed and is designed to focus on those dates when disbursements made by the employer were not recorded as received in full by the vendor.

Thus, the fund release review monitor module can automatically compare invoice totals from a vendor with actual charges (fund releases) from an employer allowance or treasury account. This automatic control can, for example, help ensure the following:
1) payments are only made to pre-approved vendors (e.g., approved routing numbers);
2) payments are only made for invoices that were properly submitted, approved and recorded by approved vendors, corporate management, and the treasury department/bank;
3) the employer and the treasury department/bank are adequately controlling their payment release process;
4) hidden wire transfer requests have not been submitted and invalid payments have not been made; and
5) the employer is equipped with evidence to recover any over-payments accidentally released by the employer or any wire transfer requests inappropriately submitted by an invalid requestor.
   Employer General Ledger Auditor Module

Another embodiment includes am employer general ledger auditor module to support a more complete general ledger (G/L) entry review and approval process by automatically performing an audit of entries to the G/L accountable to the health benefits expense payment made to a vendor. This module can help mitigate the risk of inappropriate entries to the G/L. By comparing the total amounts released from the employer's bank account to a vendor, along with the total amounts posted to the G/L within that vendor account, the risk of under or over reporting the total expenses for that vendor can be reduced.

An employer's G/L is typically updated daily, weekly, or monthly (i.e., on a periodic or batch basis) with data (referred to as postings) including the amounts of funds released (either through a treasury or by a bank) for payment of vendor invoices. The amount posted to the G/L can include the employer's recognized health benefits expense for a prescribed vendor and for a prescribed period of time. In some cases, the treasury department of the employer will communicate the total transaction activity to an accounting department that will make the entries in the G/L, and sometimes to a sub-ledger. In other cases, the transactions are electronically posted to the G/L in real time when the amounts are released (either through an electronic treasury system or bank account). Risk exposure exists at this stage of the expenditure cycle and can include, but may not be limited to the following:
1) the amount of funds released from a treasury or bank is not posted to the appropriate G/L account;
2) the amount of funds released from a treasury or bank is not posted accurately, timely, or completely to the G/L (i.e., the bank released funds that were not accounted for, or an expense was posted, but the money was never actually released).
3) the total amount of health benefits expense for a specific vendor that is reported in an Income Statement is inaccurate (under or over reported expense) and/or the total amount of Cash Assets reported in the Balance Sheet is inaccurate (under or over reported cash assets in the bank account).

An employer is typically responsible for implementing internal controls (review and approval controls) to control the accounting and G/L postings and to mitigate the risk of inaccurate/incomplete financial reporting. To help ensure that journal entries into the G/L are complete, accurate, and valid, the employer general ledger auditor module can support the employer's accounting practices and journal entry review and approval process, and provide a set of internal controls to confirm that each journal entry is complete, accurate, and valid. The employer general ledger auditor module includes, for example, the following tasks:
1) automatically compare the fund releases (transaction activity) by the bank or treasury system (e.g., in total and for the specific routing number(s)) with the actual G/L postings for the same period; and
2) match each bank transaction to the corresponding G/L entry to confirm that the expense was recognized at the right time.

This embodiment can be embodied in a processor-readable medium storing code to compare a first electronic data set with a second electronic data set. The first electronic data set can represent, for example, information associated with bank account transaction activity (debits, credits and payees in the account) and the second electronic data set can include postings included on a G/L that are associated with a particular expense payment, or in aggregate for a period (i.e., week, month, quarter, year). The processor can automatically identify fund releases that cannot be matched to a respective G/L entry or posting, or likewise, expense postings in the G/L which cannot be validated by actual releases of cash assets to that particular vendor. Thus, amounts released by an employer bank account or treasury that have not been recognized as expenses; amounts recognized as expenses in the G/L that were not actually released by the bank or treasury; inaccurate (dollar) postings to the G/L; inaccurate adjusting entries to the G/L; unauthorized access to create/change/delete postings within the G/L system; under or over reporting of health benefits expenses for a particular vendor or as a whole; and accidental expense recognition to the wrong vendor/payee can be identified.

The employer general ledger auditor module can automatically compare employer payment amounts (fund releases) with control totals within the G/L and subsequently to the individual business unit expense accounts. This automatic comparison will help ensure, for example, the following:
1) health benefits expense accounts/report totals are reasonable;
2) health benefits expenses have not been overstated or understated; and
3) forecasts, reserve estimations, and funding requirements can be calculated with reliable data.

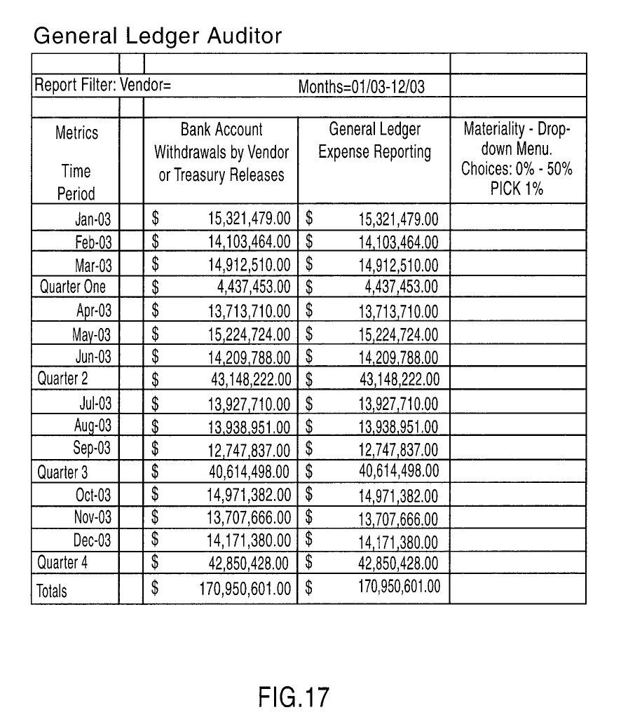

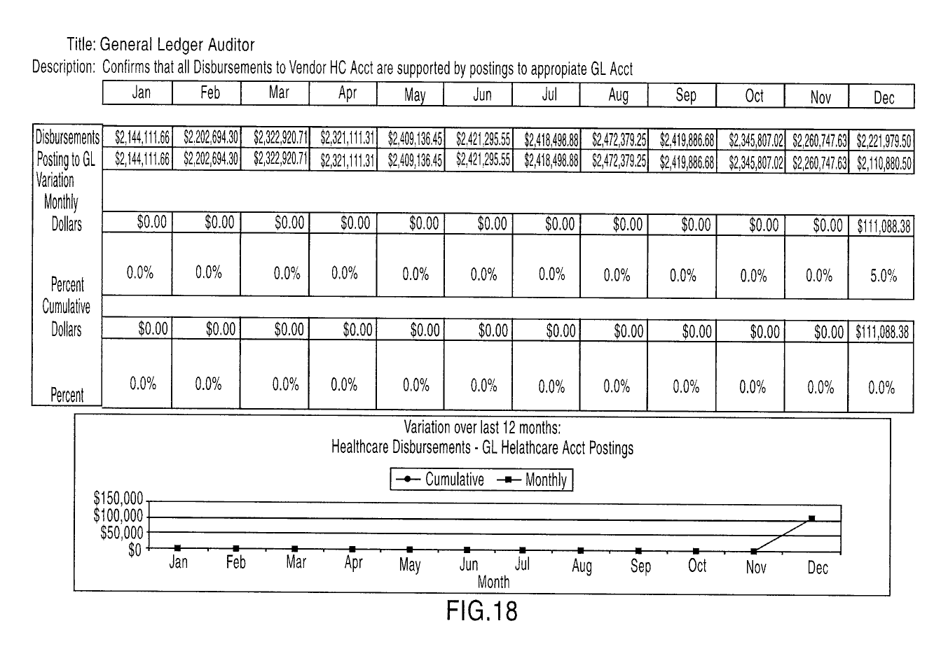

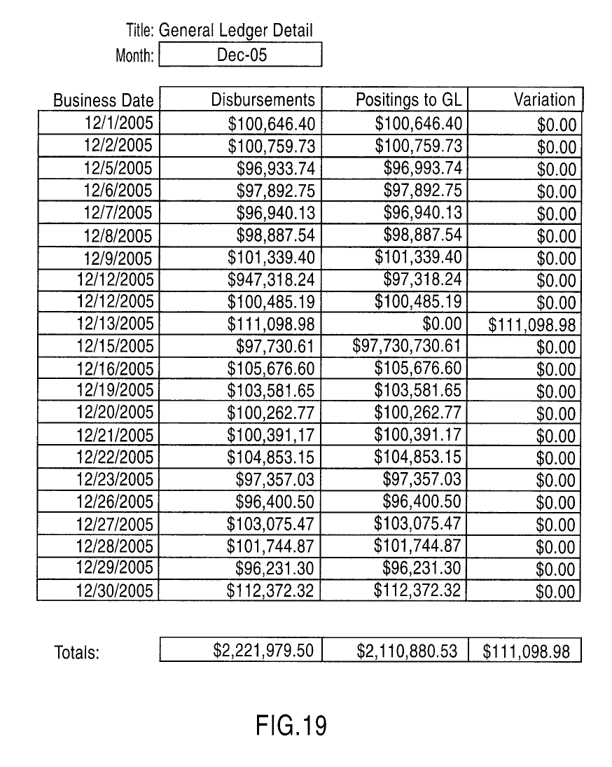

Example reports that can be generated by the employer general ledger auditor module are illustrated in FIGS. 17-19. FIG. 17 illustrates a report that shows bank account withdrawals by a vendor or treasury releases from the employer, and general ledger expense postings. FIG. 18 illustrates a report that shows that all disbursements made by the employer to the healthcare provider are properly posted in the appropriate general ledger. This report is designed to confirm that all disbursements made by the employer to the healthcare vendor were properly posted to the appropriate healthcare expense account in the general ledger. An alert will indicate specific dates when such comparisons show discrepancies. Again, this data can be parsed to help determine the root cause of the discrepancy. FIG. 19 illustrates a drill-down report for the general ledger, and shows those situations when disbursements made by the employer to the healthcare vendor are not supported by postings to the appropriate general ledger account. This report is designed to identify the source of the discrepancy between disbursements made by the employer and postings to the general ledger for healthcare expense reporting.

Systems Process Assurance Manager Module

Another embodiment includes a module that can also be embodied in a computer-readable medium storing code. This module is referred to as the systems process assurance manager and can be used to create a single view of the entire expenditure cycle. This module can allow an employer to regularly monitor the flow of transactions; starting with actual processed claims captured in the vendor claims processing systems, and ending with actual expense totals booked to the employer's G/L system. This module includes a process assurance dashboard that can be monitored by, and shared with, various departments within an employer, such as the CFO, Benefits Finance, Internal Audit, and even with external auditors, and can help the employer to identify the data point at which a transactional error may have occurred.

A processor including the process assurance manager module can receive an electronic data set associated with a plurality of claims under a benefits plan, a plurality of invoices associated with the benefits plan, a plurality of payments from a vendor (e.g., check-runs to a provider), a plurality of fund release records (bank account transaction activity) from an employer (plan sponsor), and a plurality of general ledger postings from the employer's internal/external accounting systems. The information received can be arranged into a single view (i.e., a single report) or multiple views.

This module also includes a monitoring feature that allows the user to adjust an automatic monitoring feature based on a materiality threshold set at the user's discretion. The materiality threshold can be, for example, a parameter, such as a percentage value (e.g., 1% to 100%) representing a value associated with a comparison between data entries received. For example, both upper threshold parameters and lower threshold parameters can be set. The monitoring feature can include color indicators that are associated with various comparison states. For example, green can indicate no materiality threshold has been exceeded, red can indicate an upper materiality threshold is exceeded, and yellow can indicate that a lower materiality threshold is exceeded. In addition, other possible color labeling and alerting features can be used. This red/yellow/green labeling system automatically highlights points of comparison among data sources that are at variance beyond a material threshold (e.g., invoice amount should equal paid amount allowing for timing differences, and paid amount should equal expense amount recorded in the general ledger system). Although only discussed with respect to this module, the monitoring feature described above can be included with any of the modules described herein.

With this module, for example, a first electronic data set can be compared with a second electronic data set, the second electronic data set can be compared with a third electronic data set, the third electronic data set can be compared with a fourth electronic data set, and the fourth electronic data set can be compared with a fifth electronic data set, and so on. In one example, the first electronic data set can represent information associated with a plurality of claims under a benefit plan, and the second electronic data set can represent evidence of invoices/bills generated by vendors (medical, pharmaceutical, or third party administrator). This data can be acquired from a vendor's claims adjudication system and check clearing account to determine/verify the authenticity of the claims included in an invoice and to ensure that each claim (within an invoice) was actually submitted by a provider and truly processed to completion by the vendor's claims adjudication system.

The second electronic data set can also be compared with the third electronic data set, which can represent, for example, evidence of vendor payments to providers. This data can be acquired from the vendor's claims adjudication system and check clearing account to determine/verify that the claims included in all invoices (to employers) were actually paid to a provider before being included in the invoice. The third electronic data set can also be compared with the fourth electronic data set, which can represent, for example, evidence of electronic charges and subsequent fund releases (payments) made by the employer to the vendor. This data can be acquired from the vendor's check clearing account and from the employer's bank (trust and non-trust accounts) and/or from the employer's internal payment/treasury system. The data can be used to determine/verify that the amounts requested (invoiced by the vendor in question) can be matched with actual funding amounts released by the employer's bank or made by the internal payment/treasury system. This comparison can support a more complete review and approval of amounts paid, and mitigate the risk of lost cash assets.

The fourth electronic data set can also be compared with the fifth electronic data set, which can represent, for example, information associated with evidence of actual expenses posted to an accounting system where said expense payments are recorded (debit entries/postings), such as a general ledger, that can create, influence, or impact (both material and immaterial) the financial statements of an employer (e.g., the cash flow statement, the income statement, and the balance sheet). This data can be acquired from the employer's bank (trust and non trust accounts) and/or from the employer's internal payment/treasury system. This comparison can be performed to help ensure that the expense amounts being reported within financial reports are accurate, complete and valid by comparing the accounting entries with evidence of actual cash payments/releases to vendors.

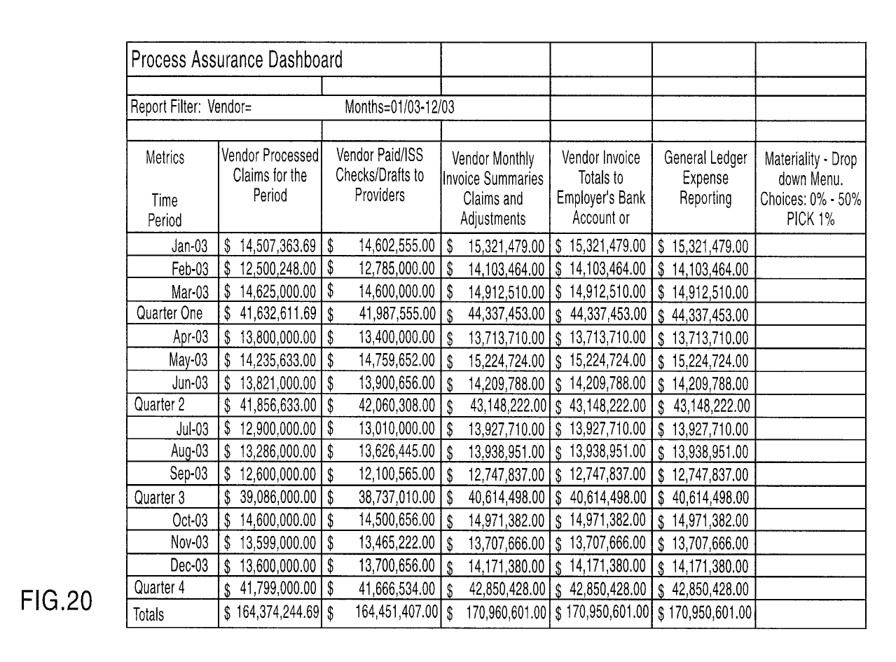

With this embodiment, an employer can monitor the flow of transactions; such as, processed claims captured in a vendor claims processing system, and actual expense totals booked to an employer's general ledger. The process assurance manager module can be monitored and shared with various departments within an employer, such as, the CFO, Benefits Finance, Internal Audit, and with external auditors. An example report that can be generated by the systems process assurance manager module is illustrated in FIG. 20.

Control Center—Monitoring and Error Alert

In another embodiment, a module automatically alerts a user of errors identified by any of the above-described methods/modules. This module includes a control center—monitoring and error alert module. Again, materiality and other parameters can be set and saved by the user. Automatic audits and controls can be performed based on the selected settings. An employer can select any of a variety of nodes to access the related reports. A node as used here refers to a selectable icon on the control center screen. For example, if a report has an error associated with a particular report, the node associated with that report can be set to blink red. The employer can then select that node to investigate the error, resolve the error, and/or document the correction.

The control center—monitoring and error alert module can be embodied on a processor-readable medium storing code to present or display a report associated with the user's health benefits expenditure cycle. The report can be presented, for example, diagrammatically. The report can include a variety of nodes. Each node within the report can automatically assume the color labeling functionality. Each node can also include other alert features, such as other visual or audible indicators. Thus, the user can monitor the work flow process of an expense cycle from this main control center screen.

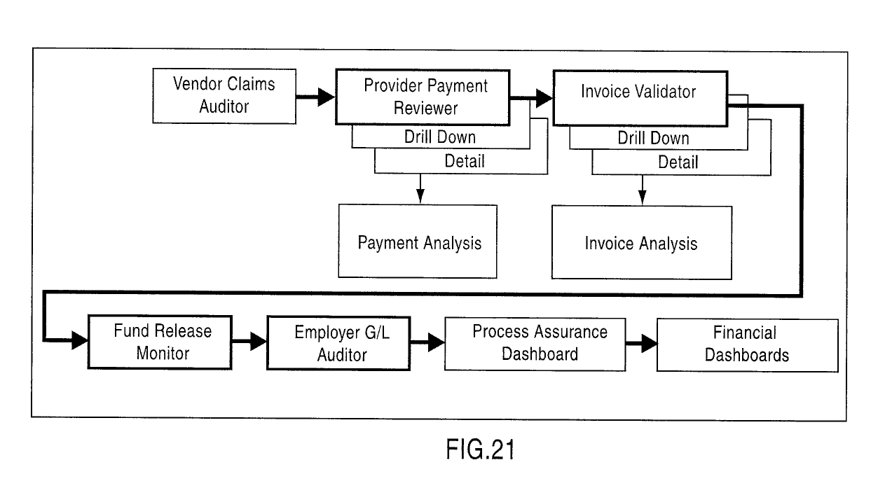

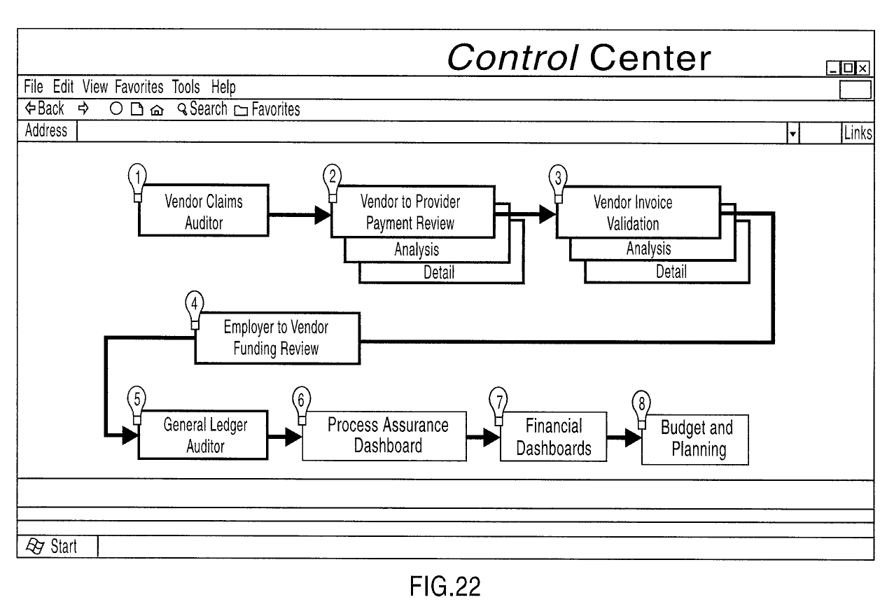

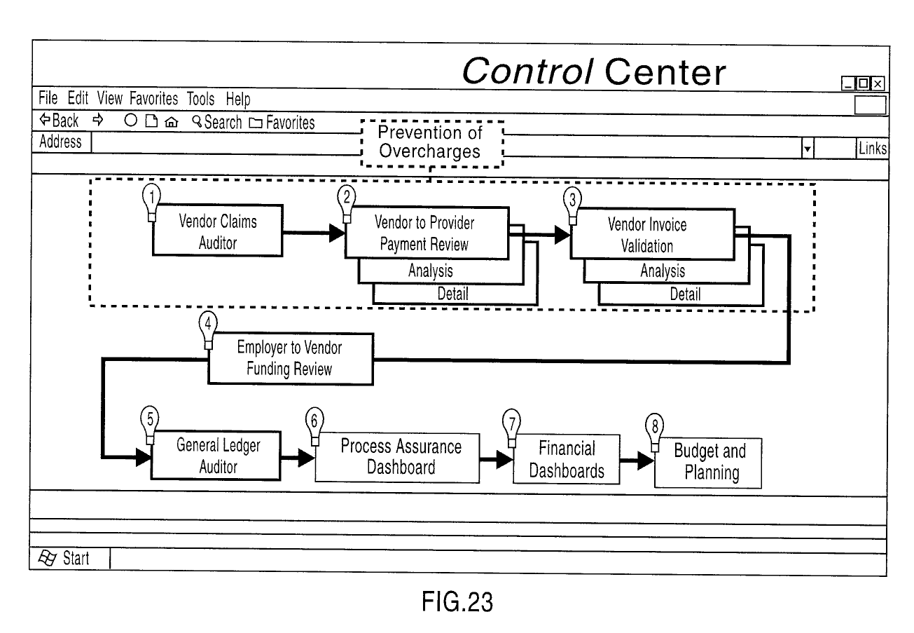

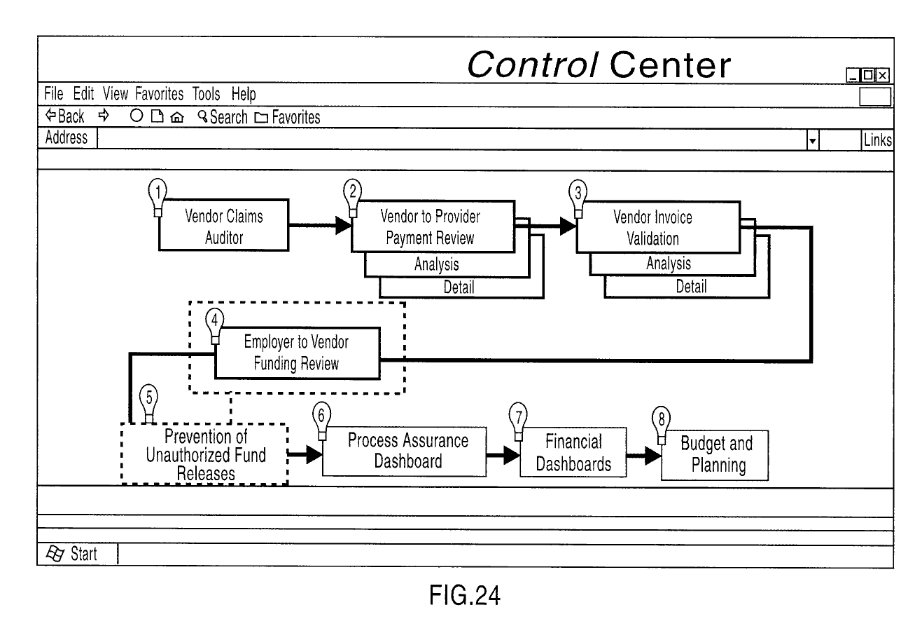

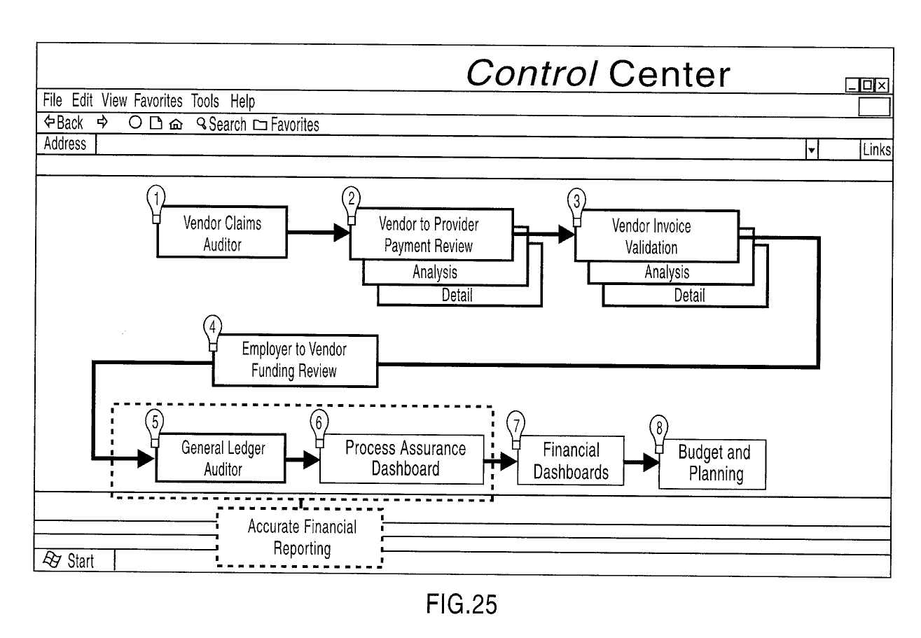

Example reports and screen-shots that can be generated by the control center—monitoring and error alert module are illustrated in FIGS. 21-25. FIG. 21 illustrates a control center report that provides the user, at a glance, the overall status of any of the processes monitored by any of the above described modules. Each of the buttons or nodes on the report are linked to an underlying report. The nodes can be color identified as described above, for example, green to indicate no materiality threshold has been exceeded, red to indicate the upper materiality threshold is exceeded (as set by the user), and yellow to alert that the lower materiality threshold is exceeded. FIGS. 22-25 illustrate example screen shots that can be produced using the control center—monitoring and error alert module.

Other possible additional features and activities that can be included in one or more of the above-described methods/programs/modules include, for example, the following:
1) vendor performance reviews;
2) claims validation and error detection, reporting, and resolution control;
3) invoice review and approval control;
4) over-billing detection and resolution control;
5) payment review and approval control;
6) over-payment detection and resolution control;
7) accounting review control;
8) inaccurate accounting/fraud detection and resolution control; and
9) process monitoring control.

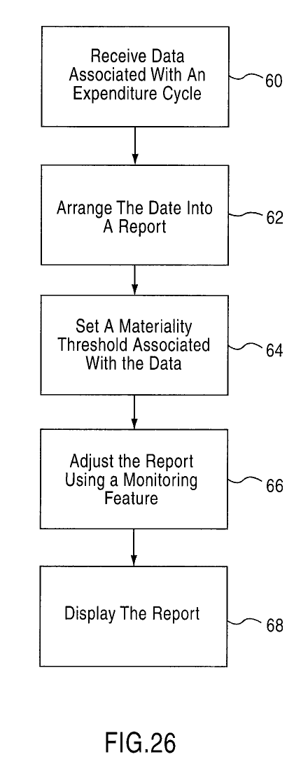

A method according to an embodiment of the invention is illustrated in a flowchart in FIG. 26. A method includes at step 60 receiving data associated with an expenditure cycle for a benefits plan. The data can include a plurality of claims under a benefits plan, receiving a plurality of invoices associated with the plurality of claims, receiving data associated with a plurality of payments paid by a vendor to a provider, receiving a plurality of fund release records, and receiving a plurality of general ledger postings. At step 62 the data associated with a plurality of claims, the plurality of invoices, the data associated with a plurality of payments paid by a vendor to a provider, the plurality of fund release records, and the plurality of general ledger postings are arranged into a single report. At step 64 a materiality threshold can be set based on an input by a user. The materiality threshold can be associated with a particular comparison between data received. More than one materiality threshold can be set and more than one threshold can be set for a given comparison. The report can bee adjusted using a monitoring feature associated with the report based on criteria input by a user at step 66. The monitoring feature can include a color labeling system configured to automatically highlight points of comparison between data sets included in the report. The report is displayed at step 68. The report can be displayed in a variety of different formats, for example, the report can include diagrams, tables, graphs, etc.

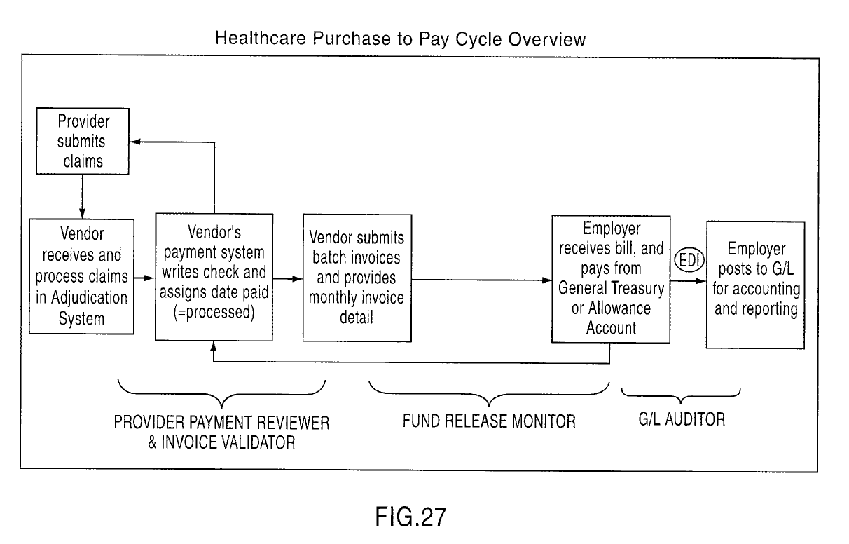

FIG. 27 is a schematic illustration of an expenditure cycle that summarizes where some of the various modules described above typically come into play within the expenditure cycle. This figure demonstrates where the data used within the particular modules is being provided from. For example, the vendor invoice reviewers modules, which includes the claims auditor module (including the duplicate claims auditor function and the claims eligibility auditor function) and the provider payment reviewer and invoice validator module, utilize data associated with the vendor adjudication system, the vendor payment system and vendor invoices. The employer fund release auditor module uses data associated with vendor invoices and employer payments, either from the employer's treasury or a bank allowance account. The employer general ledger auditor module uses data associated with the employer payments, and the employer general ledger.

### CONCLUSION

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents. While the invention has been particularly shown and described with reference to specific embodiments thereof, it will be understood that various changes in form and details may be made.

For example, although the above description focuses on comparing data sets to determine discrepancies between the data sets, all of the modules can also identify consistencies between the data sets. For example, the various modules can identify whether there is a claim that can be matched to an eligibility record, whether a claim in a vendor invoice has been included in a claim paid to a provider, whether there is a fund request that can be matched to a fund release, and whether there is a fund release that can be matched to a general ledger posting.

What is claimed is:

1. A processor-readable medium storing code representing instructions to cause a processor to perform a process, the code comprising code to:
receive an electronic data set including information associated with a plurality of claims under a benefit plan;
search the data set for a first claim from the plurality of claims that includes at least one detail in common with a second claim from the plurality of claims;
generate a report including the first claim and the second claim; and
identify whether there is a duplication of a charge for the first claim or a duplication of charge for the second claim included in a vendor invoice received from a vendor.

2. The processor-readable medium of claim 1, wherein the at least one detail includes at least one of a claimant name, a claim provider, a claim date, a claim incurred, a claim paid date, a service code modifier, or a claim amount.

3. The processor readable medium of claim 1, the code further comprising code to:
adjust a monitoring feature associated with the report based on criteria input by a user, the monitoring feature including at least one color label configured to highlight points of comparison between the first claim and the second claim.

4. The processor-readable medium of claim 1, further comprising code to:
display the report, the report including at least one of a graph, a table, a chart, or a diagram.

5. The processor-readable medium of claim 1, further comprising code to:
set a materiality threshold associated with the electronic data set based on a user input.

6. A processor-readable medium storing code representing instructions to cause a processor to perform a process, the code comprising code to:
compare a first electronic data set with a second electronic data set, the first electronic data set including information associated with a plurality of claims under a benefit plan, the second electronic data set including information associated with a plurality of eligibility records associated with the plurality of claims; and
identify whether there is a claim from the plurality of claims based on a claim date included within a time period that can be one of matched to an eligibility record from the plurality of eligibility records for the time period and not matched to an eligibility record from the plurality of eligibility records for the time period.

7. The processor-readable medium of claim 6, the code further comprising code to:
identify whether a claim identified as not matched to an eligibility record has an associated paid date and whether that claim is included in an invoice received from a vendor.

8. The processor readable medium of claim 6, the code further comprising code to:
adjust a monitoring feature associated with the first electronic data set and the second electronic data set based on criteria input by a user, the monitoring feature including at least one color label configured to highlight points of comparison between the first electronic data set and the second electronic data set.

9. The processor-readable medium of claim 6, further comprising code to:
display a report associated with the first electronic data set and the second electronic data set, the report including at least one of a graph, a table, a chart, or a diagram.

10. The processor-readable medium of claim 6, further comprising code to:
set a materiality threshold associated with the first electronic data set and the second electronic data set based on a user input.

11. A processor-readable medium storing code representing instructions to cause a processor to perform a process, the code comprising code to:
compare a first electronic data set with a second electronic data set;
the first electronic data set including information associated with a plurality of claims paid by a vendor to a provider, the second electronic data set including a plurality of claims included in a vendor invoice to an employer; and
identify whether a claim from the plurality of claims included in a vendor invoice has been one of included in a claim paid to a provider and not included in a claim paid to a provider.

12. The processor-readable medium of claim 11, further comprising code to:
identify a time period between when an employer is charged for a claim based on the second electronic data set and when that claim is paid to a provider based on the first electronic data set.

13. The processor readable medium of claim 11, the code further comprising code to:
adjust a monitoring feature associated with the first electronic data set and the second electronic data set based on criteria input by a user, the monitoring feature including at least one color label configured to highlight points of comparison between the first electronic data set and the second electronic data set.

14. The processor-readable medium of claim 11, further comprising code to:
display a report associated with the first electronic data set and the second electronic data set, the report including at least one of a graph, a table, a chart, or a diagram.

15. The processor-readable medium of claim 11, further comprising code to:
set a materiality threshold associated with the first electronic data set and the second electronic data set based on a user input.

16. A processor-readable medium storing code representing instructions to cause a processor to perform a process, the code comprising code to:
compare a first electronic data set with a second electronic data set, the first electronic data set including information associated with a plurality of charges included within a vendor invoice received at an employer and a plurality of fund requests, the second electronic data set including information associated with a plurality of fund releases; and
identify whether there is a fund request from the plurality of fund requests that can be one of matched to a fund release from the plurality of fund releases and not matched to a fund release from the plurality of fund releases.

17. The processor-readable medium of claim 16, the code further comprising code to:
identify whether there is a fund release that can be one of matched to a pre-approved routing number and not matched to a pre-approved routing number.

18. The processor readable medium of claim 16, further comprising code to:
identify whether there is a fund request from the plurality of fund requests that is requested by an unauthorized requester.

19. The processor readable medium of claim 16, further comprising code to:
identify whether there is a fund release from the plurality of fund releases that is unauthorized.

20. The processor readable medium of claim 16, further comprising code to:
identify whether there has been an unauthorized access to modify a fund release.

21. The processor-readable medium of claim 16, the code further comprising code to:
identify whether there is a fund release that is associated with an authorized pre-approved routing number but includes an incorrect amount.

22. The processor readable medium of claim 16, the code further comprising code to:
adjust a monitoring feature associated with the first electronic data set and the second electronic data set based on criteria input by a user, the monitoring feature including at least one color label configured to highlight points of comparison between the first electronic data set and the second electronic data set.

23. The processor-readable medium of claim 16, further comprising code to:
display a report associated with the first electronic data set and the second electronic data set, the report including at least one of a graph, a table, a chart, or a diagram.

24. The processor-readable medium of claim 16, further comprising code to:
set a materiality threshold associated with the first electronic data set and the second electronic data set based on a user input.

25. A processor-readable medium storing code representing instructions to cause a processor to perform a process, the code comprising code to:
compare a first electronic data set to a second electronic data set, the first electronic data set including information associated with a plurality of fund releases and the second electronic data set including information associated with a plurality of general ledger postings; and
identify whether there is a fund release from the plurality of fund releases that can be one of matched to a general ledger posting from the plurality of general ledger postings and not matched to a general ledger posting from the plurality of general ledger postings.

26. The processor-readable medium of claim 25, further comprising code to:
identify an inaccurate posting in the plurality of general ledger postings.

27. The processor-readable medium of claim 25, further comprising code to:
identify an unauthorized access to a posting from the plurality of general ledger postings.

28. The processor readable medium of claim 25, the code further comprising code to:
adjust a monitoring feature associated with the first electronic data set and the second electronic data set based on criteria input by a user, the monitoring feature including at least one color label configured to highlight points of comparison between the first electronic data set and the second electronic data set.

29. The processor-readable medium of claim 25, further comprising code to:
display a report associated with the first electronic data set and the second electronic data set, the report including at least one of a graph, a table, a chart, or a diagram.

30. The processor-readable medium of claim 25, further comprising code to:
set a materiality threshold associated with the first electronic data set and the second electronic data set based on a user input.

31. A processor-readable medium storing code representing instructions to cause a processor to perform a process, the code comprising code to:
receive a first data set including data associated with a plurality of claims under a benefits plan;
receive a second data set including a plurality of invoices associated with the plurality of claims;
receive a third data set including data associated with a plurality of payments paid by a vendor;
receive a fourth data set including a plurality of fund release records;
receive a fifth data set including a plurality of general ledger postings; and
arrange the first data set, the second data set, the third data set, the fourth data set and the fifth data set data into a single report.

32. The processor-readable medium of claim 31, the code further comprising code to:
adjust a monitoring feature associated with the report based on criteria input by a user, the monitoring feature including at least one color label configured to indicate a discrepancy between one of the first data set, the second data set, the third data set, the fourth data set, and the fifth data set and another one of the first data set, the second data set, the third data set, the fourth data set, and the fifth data set

33. The processor-readable medium of claim 31, further comprising code to:
display the report; and
adjust a monitoring feature based on input by a user.

34. The processor-readable medium of claim 31, further comprising code to:
display the report, the report including at least one of a graph, a table, a chart, or a diagram.

35. The processor-readable medium of claim 31, further comprising code to:
set a materiality threshold based on a user input.

36. A method, comprising:
receiving a first data set including data associated with a plurality of claims under a benefits plan;
receiving a second data set including a plurality of invoices associated with the plurality of claims;
receiving a third data set including data associated with a plurality of payments paid by a vendor;
receiving a fourth data set including a plurality of fund release records;
receiving a fifth data set including a plurality of general ledger postings; and
arranging the first data set, the second data set, the third data set, the fourth data set, and the fifth data set into a single report.

37. The method of claim 36, further comprising:
adjusting a monitoring feature associated with the report based on criteria input by a user, the monitoring feature including at least one color label configured to indicate a discrepancy between one of the first data set, the second data set, the third data set, the fourth data set, and the fifth data set and another one of the first data set, the second data set, the third data set, the fourth data set, and the fifth data set.

38. The method of claim 36, further comprising:
displaying a report, the report including a color indicator; and
adjusting a monitoring feature based on input by a user.

39. The method of claim 36, further comprising:
displaying a report, the report including at least one of a graph, a table, a chart, or a diagram.

40. The method of claim 36, further comprising:
setting a materiality threshold based on a user input.

41. A processor-readable medium storing code representing instructions to cause a processor to perform a process, the code comprising code to:
display a first report associated with an expenditure cycle, the first report including a plurality of nodes, each node from the plurality of nodes being associated with a comparison report associated with data received for the expenditure cycle, each node from the plurality of nodes having an indicator;
display a second report based on a user selection of one node from the plurality of nodes; and
display a third report, the third report including data associated with the selected node from the plurality of nodes.

42. The processor-readable medium of claim 41, wherein the indicator includes a color.
